(19) United States
(12) Patent Application Publication
(10) Pub. No.: US 2026/0185574 A1
(43) Pub. Date: Jul. 2, 2026

(54) Brake pad and disc brake

(71) Applicant: BPW Bergische Achsen Kommanditgesellschaft, Wiehl (DE)

(72) Inventor: Torsten Schumacher, Nümbrecht (DE)

(73) Assignee: BPW Bergische Achsen Kommanditgesellschaft, Wiehl (DE)

(21) Appl. No.: 18/861,787

(22) PCT Filed: Apr. 17, 2024
(86) PCT No.: PCT/EP2024/060391

§ 371 Date: Oct. 30, 2024

(30) Foreign Application Priority Data
Apr. 21, 2023 (DE) 10 2023 110 198.6

(51) Int. Cl. F16D 65/092; F16D 65/02

(52) U.S. Cl. CPC F16D 65/092; F16D 2065/026

(57) ABSTRACT

The invention relates to a vehicle brake, in particular a disc brake, and includes a backplate and a friction lining arranged on the front side of the backplate, wherein the backplate has a first radial support surface lying in a first radial plane for support against a first radial counter surface on a brake carrier or brake caliper. Furthermore, the backplate has a second radial support surface lying in a second radial plane for support against a second radial counter surface on a brake carrier or brake caliper. The first radial plane and the second radial plane are arranged to run at least largely parallel to one another, wherein the backplate has two tangential support surfaces lying in a common tangential plane for support against a tangential counter surface provided on a brake carrier or brake caliper.

The invention relates to a brake pad. The brake pad is intended for a vehicle brake, in particular for a disc brake, and comprises a backplate and a friction lining arranged on the front side of the backplate, wherein the backplate has a first radial support surface lying in a first radial plane for support against a first radial counter surface on a brake carrier or brake caliper. Furthermore, the backplate has a second radial support surface lying in a second radial plane for support against a second radial counter surface on a brake carrier or brake caliper. The first radial plane and the second radial plane are arranged to run at least largely parallel to one another, wherein the backplate has two tangential support surfaces lying in a common tangential plane for support against a tangential counter surface provided on a brake carrier or brake caliper. Furthermore, the invention also relates to a disc brake.

DE 20 2005 005 798 U1 discloses a floating-caliper disc brake, in particular for utility vehicles, having a brake carrier, a brake disc, a brake caliper overlapping the brake disc, and brake pads. The brake pads are inserted from the outside into a pad shaft from the radial direction, with the surfaces of the pad shaft being arranged at right angles to one another.

EP 3 027 926 B1 and DE 10 2013 012 547 B4 disclose a U-shaped shaft for a brake pad in a disc brake. Supporting portions are inclined according to a center plane to correspond to a backplate of the brake pad to prevent confusion between an outer and an inner brake pad. However, this can only be achieved on one side of the disc brake, since the embodiment shown only allows the brake pads to be installed in the axial direction. Incorrect installation of the brake pad with the backplate relative to the brake disc cannot be prevented.

The prior art has the disadvantage that installation with the backplate of the pad facing the brake disc is possible, even if the correct pad is selected.

JP 2008-196 683 A discloses a disc brake for vehicles, wherein the brake pads are offset from one another in the direction of rotation of the brake disc and additional wedge elements are arranged on their radial surfaces.

DE 1525385 A discloses a spot-type disc brake, in particular for motor vehicles, having brake shoes consisting of brake pads with backplates. The brake shoes are supported in such a way that actuating devices remain unloaded by the braking forces, thereby preventing the actuating device from jamming and bending.

A friction shoe in which, with respect to the main direction of rotation, at least the inlet-side edge of the friction material block is inclined at least with the greater part of its length in the main direction of rotation is disclosed in DE 3109939A1 .

US 2022/0163079 A1 Discloses a brake pad for a disc brake having a brake disc rotating about an axis, in which support surfaces of the brake pad and the pad carrier on an underside are inclined toward or away from the brake disc.

EP 0 752 541 A1 proposes an asymmetrical design of both pads, including their backplates and guide surfaces, which are intended to prevent twisted installation of the pads. However, these designs are unfavorable in production and, among other things, reduce the surface area of the friction lining.

DE 20 2004 021 249 U1 discloses a disc brake having brake pads with recesses for corresponding projections in a brake caliper or in a brake carrier. This is intended to prevent twisted installation of the brake pad with the backplate relative to the brake disc. However, the brake pads must be subsequently provided with the recesses and additional projections must be formed on the brake caliper and/or the brake carrier in the relevant pad shaft.

The invention is based on the object of providing a brake pad or a vehicle brake with a high level of process reliability during assembly and with a simplified structure compared to the prior art.

The object of the invention is achieved by a brake pad for a vehicle brake according to claim 1. The brake pad is characterized in particular in that the tangential plane forms an acute angle with the first radial plane and an obtuse angle with the second radial plane.

A vehicle brake is a disc brake which comprises a pad holder for the brake pad and a brake disc arranged about a brake center axis.

The support surfaces of the brake pad according to claim 1 are to be understood as those surfaces of the brake pad which, during the braking process, transfer the braking forces and moments to corresponding support surfaces or counter surfaces of a brake carrier or a brake caliper.

A brake pad center plane lies centrally between the first radial plane and the second radial plane and runs through the brake center axis when the brake pad is inserted into the pad holder.

The invention has the advantage that, when installing the brake pad in a pad holder of the brake caliper or the brake carrier, the friction lining always points in the direction of the brake disc and thus correct installation is always guaranteed. As a result of the arrangement of the tangential plane with the first and the second radial plane, the brake pad can only be inserted the right way round, because a twisted brake pad protrudes from the brake caliper or brake carrier, so that it is not possible to attach the brake pad, in particular with hold-down devices, or the vehicle wheel is even blocked by the protruding brake pad. In contrast, a correctly inserted brake pad does not protrude from the brake carrier or brake caliper or only protrudes to the intended extent, can be securely attached and thus ensures that the disc brake functions correctly. In other words: a mechanic who installs a brake pad according to the invention in a disc brake can immediately see whether the brake pad has been inserted correctly, even in poor light and visibility conditions, and can correct the installation position of the brake pad if necessary. Thus, the assembly and functional reliability of a disc brake can be increased by means of a brake pad according to the invention.

A further advantage of the invention is that additional machining steps and complicated shaping of the brake pad and/or the backplate can be dispensed with during manufacture. There is no need to create recesses or machine surfaces that are offset from one another. In particular, the machining of the tangential support surfaces is simplified.

A brake pad according to the invention offers a further advantage, since the first radial support surface can be made larger than the second radial support surface and thus a surface pressure resulting from the circumferential forces during braking in the tangential direction between the brake disc and the pad on the first radial support surface can be reduced.

Advantageously, the acute angle lies in an angular range of 84° to 89°, preferably 86° to 88°, more preferably 87° to 88°, and the obtuse angle lies in a range of 91° to 100°, preferably 91° to 95°, wherein the sum of the degrees of the acute and the obtuse angle is equal to or almost 180°.

In these angular ranges, a sufficient overhang of the brake pads can be achieved in the event of twisted installation.

It is conceivable that the first radial length of the first radial support surface is longer than the second radial length of the second radial support surface. This allows an outer contour of an upper tangential surface of the brake pad to be adapted to an outer circumferential contour of the brake disc. Advantageously, an outer contour of the friction lining runs in sections parallel to the outer contour of the backplate. This makes the effective area of the friction lining on the brake disc as large as possible and ensures a safe braking effect. However, in regions where the backplate extends further than the friction surface of the brake disc, the friction lining is left out to ensure a safe braking process with optimal material utilization.

It is conceivable that the outer contour of the friction lining is parallel to the outer contour of the backplate in the region of the tangential support surfaces. This increases the effective area of the friction lining and ensures safe braking.

Advantageously, the entire outer contour of the friction lining is parallel to the outer contour of the backplate. In this case, the effective area is maximized. As a result, the outer contours are similar to one another, which simplifies the production of the brake pad.

It is conceivable that only at least one tangential surface is provided which lies in a tangential plane, wherein the tangential surface lies on a projection on the backplate. It is also conceivable that the radial support surfaces are limited by a tangential limiting plane in the radially outer direction, wherein the tangential plane lies further out in the radial direction than the limiting plane or in the region of the limiting plane.

The object of the invention is also achieved by a disc brake for vehicle axles according to claim 6. The disc brake comprises at least one brake disc for arrangement on a wheel hub, a brake carrier for fixed arrangement on an axle body and a brake caliper which can be arranged on the brake carrier and which overlaps the brake disc. The brake disc, the wheel hub and the axle body are arranged about a brake center axis. The brake carrier and/or the brake caliper have at least one pad holder. The pad holder has a first radial counter surface lying in a first radial plane for support against a first radial support surface of a brake pad. The pad holder has a second radial counter surface lying in a second radial plane for support against a second radial support surface of a brake pad. The first radial plane and the second radial plane are arranged to run at least largely parallel to one another. A brake center plane lies centrally between the first radial plane and the second radial plane and runs through the brake center axis. When a brake pad is inserted into the pad holder, a brake pad center plane is congruent with the brake center plane. The pad holder also has at least one tangential support surface lying in a tangential plane for support against at least one tangential support surface provided on a brake pad. It is provided that the tangential plane forms an acute angle with the first radial plane and an obtuse angle with the second radial plane.

The invention has the advantage, as described above for the brake pad according to the invention, that, when installing a brake pad in the pad holder of the brake caliper or the brake carrier, the friction lining always points in the direction of the brake disc and thus correct installation is always guaranteed.

It is advantageous if at least one brake pad with at least one radial support surface and at least one tangential support surface is provided in the pad holder, wherein the radial and tangential counter surfaces of the pad holder, i.e. the brake caliper and/or the brake carrier, are designed to correspond to the radial and tangential support surfaces of the brake pad.

This has the advantage that, if a brake pad designed to correspond to the tangential and radial counter surfaces is inserted into the disc brake, whereby a backplate and/or a friction lining of the brake pad are designed to correspond, installation with the backplate relative to the brake disc can be recognized immediately and without testing, even in poor light and/or visibility conditions. A brake pad inserted the wrong way round will protrude from the disc brake and prevent further assembly of the disc brake, such as the installation of hold-down devices, until the incorrect installation position of the brake pad is corrected. As a result of the acute and obtuse angle, only one installation position of the brake pad is possible in relation to the axial arrangement of the friction lining relative to the brake disc and the backplate away from the brake disc. The brake pads are preferably inserted from the outside into a shaft from a radial direction, which preferably forms a pad holder, in the brake carrier and/or brake caliper. Inserting the brake pads preferably does not require removing the brake caliper and/or the brake carrier.

Advantageously, the acute angle lies in an angular range of 84° to 89°, preferably 86° to 88°, more preferably 87° to 88°, and the obtuse angle lies in a range of 91° to 100°, preferably 91° to 95°, wherein the sum of the degrees of the acute and the obtuse angle is 180°.

It is conceivable that the radial and tangential counter surfaces on the brake carrier and/or on the brake caliper are designed to correspond to support surfaces of a backplate of a brake pad according to the invention. By at least largely coordinating the angles and geometrical sizes of the disc brake according to the invention and the brake pad according to the invention, a particularly high level of process reliability during assembly and a high level of safety during braking can be ensured with simple production.

It is conceivable that the disc brake according to the invention comprises two brake pads according to the invention, with an inner brake pad and an outer brake pad, wherein the inner brake pad and the outer brake pad are designed identically. This has the advantage that more identical parts can be used in the disc brake. It is also conceivable that the inner brake pad and the outer brake pad are designed differently. This can advantageously prevent twisted and/or incorrect installation of both brake pads.

Advantageously, the first radial plane, the second radial plane and the tangential plane of the disc brake according to the invention form a pad holder, wherein a first pad holder and a second pad holder are provided, each having a first radial plane, a second radial plane and a tangential plane. The planes of the first pad holder can differ from the planes of the second pad holder. The first pad holder is arranged inside the vehicle and can be provided on the brake carrier and/or on the brake caliper. The second pad holder is arranged on the outside of the vehicle and can be provided on the brake carrier and/or on the brake caliper.

Further details and advantageous designs of the invention can be found in the following description, on the basis of which embodiments of the invention are described and explained in more detail.

In the drawings:

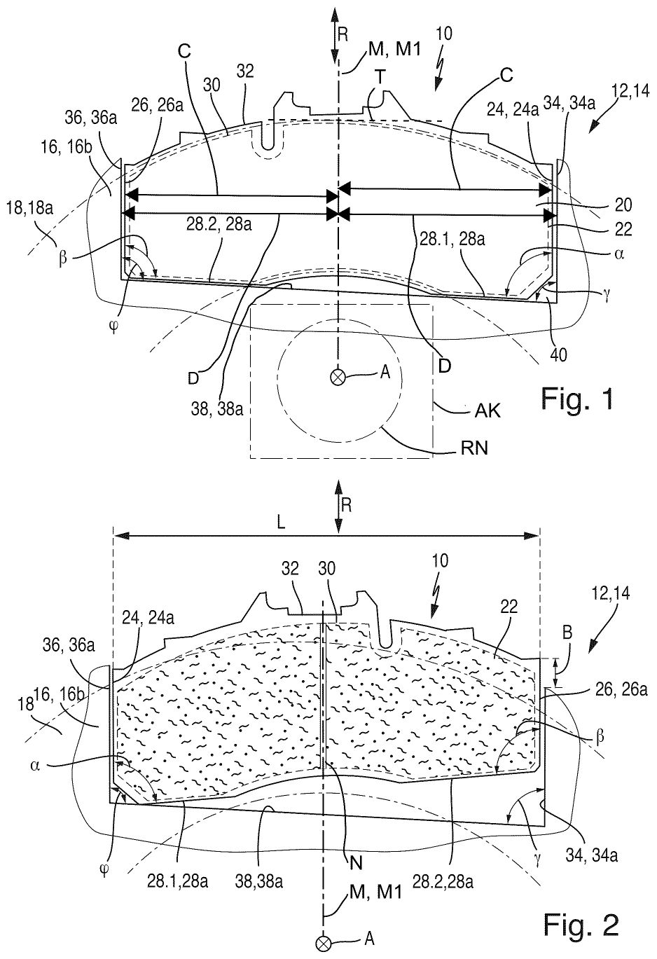

FIG. 1: shows a brake pad inserted into a disc brake;

FIG. 2: shows the brake pad according to FIG. 1 incorrectly inserted into the disc brake; and

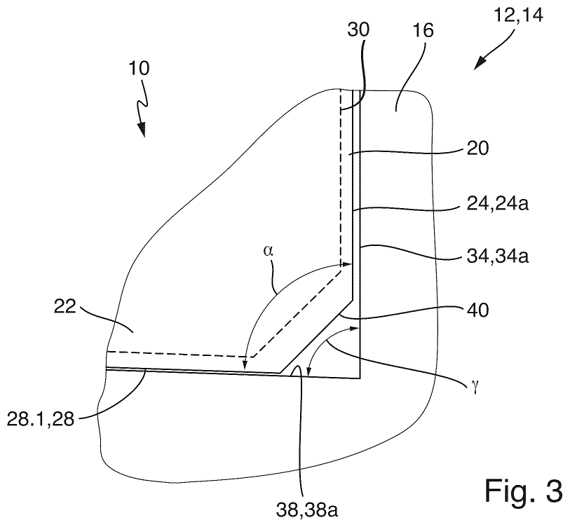

FIG. 3: is a detailed view according to FIG. 1.

FIGS. 1 and 2 show a brake pad 10 arranged in a pad holder 12 of a disc brake 14. The disc brake 14 comprises a brake carrier 16 and a brake caliper 16b overlapping a brake disc 18. The pad holder 12 shown here can be in both the brake carrier 16 and the brake caliper 16b. The brake disc 18 is arranged on a wheel hub RN. The brake carrier 16 is fixedly arranged on an axle body AK. The brake carrier 16 is intended to accommodate the brake pad 10 and to arrange the brake caliper 16b thereon. A disc brake of the type in question is shown in FIG. 3 to 5 of DE 20 2005 005 798 U1, with brake pads also arranged in the pad holders.

The brake pad 10 comprises a backplate 20 and a friction lining 22 arranged thereon and slightly set back from the backplate 20. The friction lining 22 is shown in FIGS. 1 and 3 as a dashed line of its outer contour 30, since the friction lining 20 lies behind the backplate 22 in the drawing plane. In FIG. 2, the view is such that the friction lining 20 is directly visible with its structure. Furthermore, a lining groove N is shown in the center of the friction lining 22 of the brake pad 10. The brake disc 18 is indicated by a portion of a friction ring 18a, which interacts with the friction lining 22 of the brake pad 10, and lies behind the brake pad 10 in the drawing plane, as are the axle body AK and the wheel hub RN.

The backplate 20 has a first radial support surface 24 which lies in a first radial plane 24a and a second radial section surface 26 which lies in a second radial plane 26a. The first radial plane 24a and the second radial plane 26a run at least largely parallel to one another. A brake pad center plane M runs between the first radial plane 24a and the second radial plane 26a, which is at least largely the same distance C from the two planes 24a, 26a. The brake pad center plane M therefore lies in the center between the first radial plane 24a and the second radial plane 26a. The lining groove N also runs along the brake pad center plane M. The brake pad center plane M is spanned by the brake center axis A and an orthogonal line on the brake center axis A, which runs centrally between the two planes 24a, 26a or the planes 34a, 36a. A tangent T is applied to the brake disc 18 and runs perpendicularly to the brake pad center plane M.

Furthermore, the backplate 20 has a first tangential support surface 28.1 and a second tangential section surface 28.2, which lie in a common tangential plane 28a. The planes 24a, 26a, 28a of the brake pad 10 are arranged such that the first radial plane 24a forms an acute angle α with the tangential plane 28a and the second radial plane 24a forms an obtuse angle β with the tangential plane 28a. The acute angle α lies in an angular range of 84° to 89°, preferably 86° to 88°, more preferably 87° to 88°. The obtuse angle β lies in a range of 91° to 100°, preferably 91° to 95°. The sum of the degrees of the acute and the obtuse angle α, β is 180°.

An outer contour 30 of the friction lining 22 is in sections parallel to the outer contour 32 of the backplate 20 so that the effective area of the friction lining is optimized. The outer contour 30 follows the shape of the friction ring of the brake disc 18 in order to achieve a good effect of the friction lining 22 with the brake disc 18 during braking. Because the brake pad 10 with the outer contour 30 of the friction lining 22 and/or with the outer contour 32 of the backplate 20 follows the contour of the brake disc 18 when inserted into the pad holder 12, the plane M also intersects a parallel to the tangent T at a right angle.

The illustrated pad holder 12 is formed by the brake carrier 16 and serves to hold the brake pad 10. The pad holder 12 is arranged on an inner side of the disc brake 14 in the direction toward the inside of the vehicle along the brake center axis A. The brake pad 10 is inserted in the radial direction R for installation in the disc brake 14 and is removed from the pad holder 12 in the opposite direction to the direction R for removal; the radial direction R is at least largely parallel to the brake pad center plane M. A further pad holder on an outer side, toward the outside of the vehicle along the axis A, for a second brake pad 10 can be formed by the brake caliper and/or brake carrier 16 (not shown).

The pad holder 12 comprises a first radial counter surface 34 which lies in a first radial plane 34a, a second radial counter surface 36 which lies in a second radial plane 36a, and a tangential counter surface 38 which lies in a tangential plane 38a. A brake center plane M1 lies centrally between the first radial plane 34a and the second radial plane 36a. The tangential counter surface 38 can also be divided into two tangential counter surfaces, which, however, lie in the same tangential plane 38 (not shown). The radial planes 34a and 36a are arranged at least largely parallel to one another and extend at least largely the same distance D from the brake center plane M1 M.

In FIG. 1, the planes 34a, 36a, 38a of the pad holder of the brake carrier 16 and/or the brake caliper are arranged such that the first radial plane 34a forms an acute angle γ with the tangential plane 38a and the second radial plane 24a forms an obtuse angle φ with the tangential plane 28a.

The acute angle γ lies in an angular range of 84° to 89°, preferably 86° to 88°, more preferably 87° to 88°. The obtuse angle φ lies in a range of 91° to 100°, preferably 91° to 95°. The sum of the degrees of the acute and the obtuse angle γ, φ, is 180°. The acute angles α and γ are preferably equal or in similar angular ranges. A detailed representation of the acute angles α, γ is shown in FIG. 3. If the angles α, γ differ, the angle γ is larger than the angle α in order to ensure that the brake pad 10 is inserted into the pad holder 12. The obtuse angles, β, φ are preferably equal or in similar angular ranges. If the angles β, φ are different, the angle φ is larger than the angle β in order to ensure that the brake pad 10 is inserted into the pad holder 12.

FIG. 1 shows how the brake pad 10 is inserted into the pad holder 12 the right way round with the friction lining 22 facing the brake disc 18. This can be seen from the fact that the brake pad 10 is radially flush with the brake carrier 16 and/or brake caliper in the direction R. The brake pad center plane M and the brake center plane M1 are at least largely congruent. It would also be conceivable that the brake pad 10 corresponds radially to the brake carrier 16 and/or brake caliper in the direction R. It can also be seen that the outer contour 30 of the friction lining 22 runs parallel to the outer contour of the friction ring 18a of the brake disc 18 on the radial sides. It would also be conceivable that the outer contour 30 corresponds to that of the friction ring 18a of the brake disc 18 at a certain radial distance. The acute angle α of the brake pad 10 is arranged on the acute angle γ of the pad holder 12 and the obtuse angle β of the brake pad 10 is arranged on the obtuse angle φ of the pad holder 12.

In FIG. 2, the brake pad 10 is shown inserted into the pad holder 12 the wrong way round with the friction lining 22 away from the brake disc, but the brake pad center plane M and the brake center plane M1 are at least largely congruent. The acute angle α of the brake pad 10 is arranged above the obtuse angle φ of the pad holder 12 and the obtuse angle β of the brake pad 10 is arranged above the acute angle γ of the pad holder 12. A radial overhang B in the direction R of the brake pad 10 from the pad holder 12 of the brake carrier 16 is clearly visible.

During assembly, a mechanic can directly detect this overhang B and correct the installation position of the brake pad 10 if the brake pad 10 has been inserted the wrong way round. The height of the overhang B of the incorrectly inserted brake pad 10 results from the number of degrees of the angles α, β, φ, γ, and the length L of the brake pad 10 in the tangential direction. The brake pad center plane M lies in the center of the length L. The right corner 40 of the backplate 20 of the brake pad 10 is recessed in the embodiment shown in FIG. 1-3, which is why the overhang B is smaller. The recess of the corner 40 can also be omitted, which would then result in the overhang B being larger with incorrect installation.

By means of a brake pad 10 and a disc brake 14 with surfaces 24, 26, 28.2, 28.1, 34, 26, 38 arranged in planes 24a, 26a, 28a, 34a, 26a, 38a, the process reliability during assembly of the disc brake and the safety during operation of the disc brake are increased. Ideally, the overhang B is selected to be so large that the component for fixing the brake pad 10 in the pad holder 12 cannot be installed.

### LIST OF REFERENCE SIGNS

10 Brake pad
12 Pad holder
014 Disc brake
16 Brake carrier
16b Brake caliper
AK Axle body
RN Wheel hub
18 Brake disc
20 Backplate
22 Friction lining
N Lining groove
M Brake pad center plane
M1 Brake center plane
24 First radial support surface
24a First radial plane
26 Second radial support surface
26a Second radial plane
28.1 First tangential support surface
28.2 Second tangential support surface
28a Tangential plane
α Acute angle
β Obtuse angle
φ Acute angle
γ Obtuse angle
30 Outer contour of friction lining
32 Outer contour of backplate
A Brake center axis
34 First radial counter surface
34a First radial plane
36 Second radial counter surface
36a Second radial plane
R Radial direction
38 Tangential counter surface
38a Tangential plane
40 Corner of the brake pad
C Distance between the radial planes of the brake pad and the brake pad center plane
D Distance between the radial planes of the pad holder and the brake center plane
L Length of the brake pad

1. A brake pad for a vehicle brake, for a disc brake comprising a pad holder for the brake pad and a brake disc arranged about a brake center axis having a backplate and having a friction lining arranged on the backplate,
wherein the backplate has a first radial support surface lying in a first radial plane for support against a first radial counter surface on the pad holder, wherein the backplate has a second radial support surface lying in a second radial plane for support against a second radial counter surface on the pad holder wherein the first radial plane and the second radial plane are arranged to run at least largely parallel to one another,
wherein a brake pad center plane lying centrally between the first radial plane and the second radial plane runs through the brake center axis when the brake pad is inserted into the pad holder,
and
wherein the backplate has two tangential support surfaces lying in a common tangential plane for support against a tangential counter surface provided on a brake carrier or brake caliper,
characterized in that
the tangential plane forms an acute angle with the first radial plane and an obtuse angle with the second radial plane

2. The brake pad according to claim 1, characterized in that the acute angle lies in an angular range of 84° to 89°, and the obtuse angle (β) lies in a range of 91° to 100°, wherein the sum of the degrees of the acute and the obtuse angle is equal to or almost 180°.

3. The brake pad according to claim 1, characterized in that an outer contour of the friction lining runs in sections parallel to the outer contour of the backplate.

4. The brake pad according to claim 3, characterized in that the outer contour of the friction lining is parallel to the outer contour of the backplate in the region of the tangential support surfaces.

5. The brake pad according to claim 1, characterized in that the entire outer contour of the friction lining is parallel to the outer contour of the backplate.

6. A disc brake for vehicle axles, comprising
at least one brake disc for arrangement on a wheel hub,
a brake carrier which can be fixedly arranged on an axle body, wherein the brake disc, the wheel hub and the axle body are arranged about a brake center axis, and
a brake caliper which can be arranged on the brake carrier and which overlaps the brake disc,
wherein the brake carrier and/or the brake caliper have at least one pad holder, wherein the pad holder has a first radial counter surface lying in a first radial plane for support against a first radial support surface of a brake pad,
wherein the pad holder has a second radial counter surface lying in a second radial plane for support against a second radial support surface of a brake pad in the pad holder,
wherein the first radial plane and the second radial plane are arranged to run at least largely parallel to one another,
wherein a brake center plane lying centrally between the first radial plane and the second radial plane runs through the brake center axis and, when a brake pad is inserted into the pad holder, a brake pad center plane is congruent with the brake center plane, and
wherein the pad holder has at least one tangential support surface lying in a tangential plane for support against at least one tangential support surface provided on a brake pad, characterized in that the tangential plane forms an acute angle with the first radial plane and an obtuse angle with the second radial plane.

7. The disc brake according to claim 6, characterized in that the acute angle lies in an angular range of 84° to 89°, and the obtuse angle lies in a range of 91° to 100°, wherein the sum of the degrees of the acute and the obtuse angle is equal to or almost 180°.

8. The disc brake according to any of claim 6, characterized in that at least one brake pad with at least one radial support surface and at least one tangential support surface is provided in the pad holder, wherein the radial and tangential counter surfaces of the pad holder are designed to correspond to the radial and tangential support surfaces of the brake pad.

9. The disc brake according to claim 6, characterized in that the radial and tangential counter surfaces of the pad holder are designed to correspond to support surfaces of a backplate of a brake pad.

10. The disc brake according to claim 6 having at least one brake pad, wherein, when the brake pad is inserted into the pad holder the wrong way round with the friction lining away from the brake disc, the brake pad protrudes from the pad holder with a radial overhang in a direction parallel to the brake center plane.

11. The disc brake according to claim 10 having at least one brake pad wherein the overhang is so large that a component for fixing the brake pad in the pad holder cannot be installed.
